(19) United States
(12) Patent Application Publication
(10) Pub. No.: US 2006/0190837 A1
(43) Pub. Date: Aug. 24, 2006

(54) Method for representing graphics objects and communications equipment

(76) Inventor: Alexander Jarczyk, Freising (DE)

Correspondence Address: BELL, BOYD & LLOYD, LLC, P. O. BOX 1135, CHICAGO, IL, 60690-1135, US

(21) Appl. No.: 10/560,511

(22) PCT Filed: May 19, 2004
(86) PCT No.: PCT/EP04/50845

§ 371 Date: Mar. 17, 2006

(30) Foreign Application Priority Data
Jun. 13, 2003 (DE) 10326811.1

(51) Int. Cl. G09G 5/00

(52) U.S. Cl. 715/778; 345/660; 345/661

(57) ABSTRACT

A method for representing graphic, wherein the graphic objects are located on a virtual surface field, which is larger than a display field, on which a section of the virtual surface is represented. Graphic objects that are located outside the represented section of the virtual surface field are projected onto the border of the display field.

### FIELD OF TECHNOLOGY

The present disclosure relates to a method for showing a graphics object and to an appropriate communication appliance, particularly a mobile telephone or a computer.

### BACKGROUND

The continually progressive development in the field of mobile telephones is leading to constant miniaturization of these mobile telephones, on the one hand, and to constantly improved graphics capabilities on these mobile telephones, on the other. This causes the users of such mobile telephones to want to use the graphics capabilities of the mobile telephones efficiently despite the limited available area on the display device.

In this regard, it is known practice to arrange graphics objects, such as symbols referring to a function or a program, on a virtual interface panel which is larger than an available display panel. By moving the display panel over the virtual interface panel, it is possible for the portion of the virtual interface panel which is shown on the display panel to be varied and to be selected by the user, so that the user can use a marker, for example, to select all the graphics objects shown on the virtual interface panel.

A drawback of this solution has been found to be that a user is only ever able to see part of the virtual interface panel. The user can therefore only guess the presence and position of the graphics objects which are currently not shown on the display panel but which are arranged on the virtual interface panel.

### SUMMARY

The presently disclosed embodiments are thus based on specifying a configuration that allows convenient selection of graphics objects that are arranged on a virtual interface panel which is larger than an available display panel.

Under an exemplary embodiment graphics objects, which are arranged on a virtual interface panel that is larger than an available display panel, are projected onto the edge of the display panel if they are situated outside of the detail shown from the virtual interface panel.

The effect achieved by this is that all the graphics objects arranged on a larger virtual interface panel can be shown on a small available display panel. In this case, only the part of the virtual interface panel which the user has selected by positioning the display panel over the virtual interface panel is preferably shown to scale on the display panel. By contrast, the graphics objects which are not arranged on the portion of the virtual interface panel which is covered by the display panel are shown merely projected onto the edge of the display panel.

In the present disclosure, graphics objects are also understood to mean symbols, symbol parts, icons, icon parts, display windows, display window parts, images, image details or texts or text elements and the like.

The display panel is preferably formed by a display device, such as a graphics display, or part of a display device. In particular, a display panel can be produced by a graphics window.

The virtual interface panel is preferably formed by information that is held in a memory device and which describes the positions of graphics objects relative to a reference point on the virtual interface panel. In addition to this, this information may also describe the graphics objects themselves or a scale of representation. This or other information may also determine which detail from the virtual interface panel is currently to be shown in what size of representation on the display panel. The size of representation or the scale of representation of the virtual interface panel and the graphics objects arranged thereon can be changed by the user, for example, so that the case may also arise that the representation of the virtual interface panel becomes smaller than the display panel. In this case, there is no need for graphics objects to be shown in projection.

The virtual interface panel is preferably larger than a display panel when the current length and/or width dimensions of the display panel are smaller than the current length and/or width dimensions of the virtual interface panel, the dimensions of the virtual interface panel being calculated using the scale of representation which is currently applicable in this case.

In another embodiment, a graphics object is preferably placed outside of the detail shown from the virtual interface panel when it is situated entirely or partly outside of the detail shown from the virtual interface panel, or when its center is situated outside of the detail shown from the virtual interface panel.

The projection onto the edge of the display panel covers the situation, in which the graphics object is moved entirely or partly from its actual position on the virtual interface panel in the direction of the center of the detail shown from the virtual interface panel and is shown entirely or partly in the edge region of the display panel. In this case, the edge region needs to be of wide design, in particular.

Preferably, graphics objects that are shown in projection are shown in reduced form in comparison with the scale of representation which is currently applicable for the virtual interface panel, are shown in distorted form and/or are shown as simple geometric shapes, such as lines.

The edge regions occupied by the projected graphics objects have a minimal space requirement in the case of a line representation, and the space requirement is very small even in the case of a representation using scaled semicircular projections or “half” object projections. The result is an undistorted user interface detail in the display panel which has only a minimal additional space requirement (in the extreme case it is just one pixel line of the edge region) in order to be able to provide a visual display of all the graphics objects and their spatial relationship with one another.

Preferably, the size of the representation of a projected graphics object is set on the basis of the distance between the detail shown from the virtual interface panel and the position of the graphics object. The reference point which is used to calculate the distance and which represents the detail shown is preferably formed by the center of the detail shown or of the display panel, a corner point of the detail shown or of the display panel, the point of intersection between an appropriate projection line and the edge region of the display panel, or another point in the detail shown.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a block diagram of a mobile telephone;

FIG. 2 illustrates a first exemplary embodiment of the representation and projection of graphics objects;

FIG. 3 illustrates a second exemplary embodiment of the representation and projection of graphics objects;

FIG. 4 illustrates a third exemplary embodiment of the representation and projection of graphics objects;

FIG. 5 illustrates a fourth exemplary embodiment of the representation and projection of graphics objects;

FIG. 6 illustrates a fifth exemplary embodiment of the representation and projection of graphics objects;

FIG. 7 illustrates a sixth exemplary embodiment of the representation and projection of graphics objects;

FIG. 8 illustrates a seventh exemplary embodiment of the representation and projection of graphics objects;

FIG. 9 illustrates an eighth exemplary embodiment of the representation and projection of graphics objects.

### DETAILED DESCRIPTION

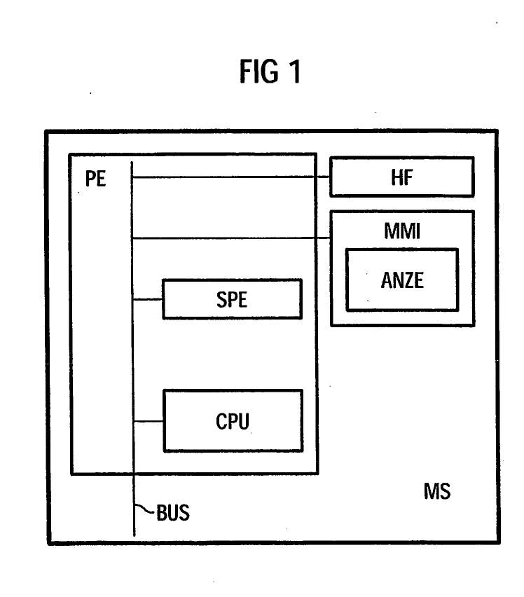

FIG. 1 shows a mobile telephone MS which contains an operator control device MMI, a radio-frequency device HF and a processor device PE. The operator control device MMI comprises a display device ANZE, such as a graphics display, and operating elements, such as keys or softkeys.

To control the mobile telephone MS, the operator control unit MMI of the mobile telephone MS and a program-controlled processor device PE, such as a microcontroller, is provided which may also comprise a processor CPU and a memory device SPE.

Depending on the specific configuration, further components may be used in association with the processor device, and may be arranged inside or outside of the processor device PE. Examples include a digital signal processor or further memory devices, the basic function of which is sufficiently well known to a person skilled in connection with a processor device for controlling a mobile telephone. The different components can interchange data with the processor CPU via a bus system BUS or input/output interfaces and other suitable controllers.

The memory device SPE stores the program data, such as the control instructions or control procedures etc., which are used for controlling the mobile telephone and the operator control unit MMI, and information for describing the virtual interface panel together with graphics objects.

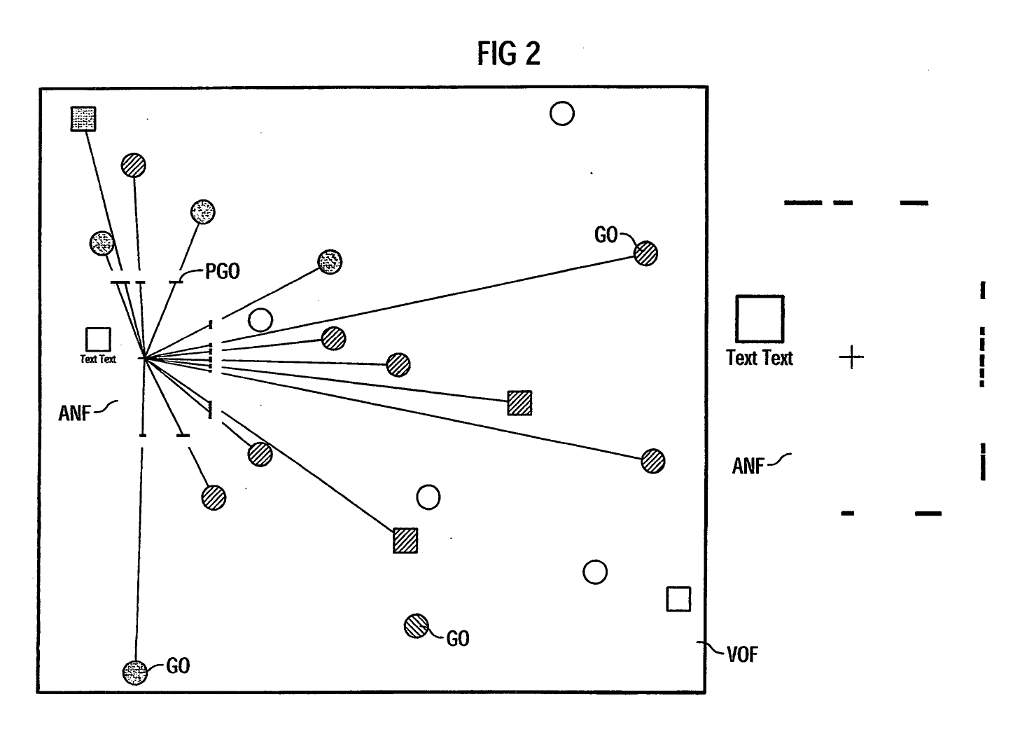

FIG. 2 shows a virtual interface panel VOF and a smaller display panel ANF, in which a detail from the virtual interface panel VOF is shown. Graphics objects GO arranged on the virtual interface panel VOF are projected onto the edge of the display panel ANF along the lines shown, with the graphics objects PGO being projected. The display panel ANF is shown once again in enlarged form on the right of FIG. 2. In line with a second embodiment of the invention, the user can move the display panel ANF over the virtual interface panel VOF or can move the virtual interface panel VOF under the display panel ANF by operating a navigation key. In addition, a change in the scale of representation or zoom factor, which relates to the virtual interface panel VOF, particularly to the portion of the virtual interface panel VOF which is shown by the display panel ANF.

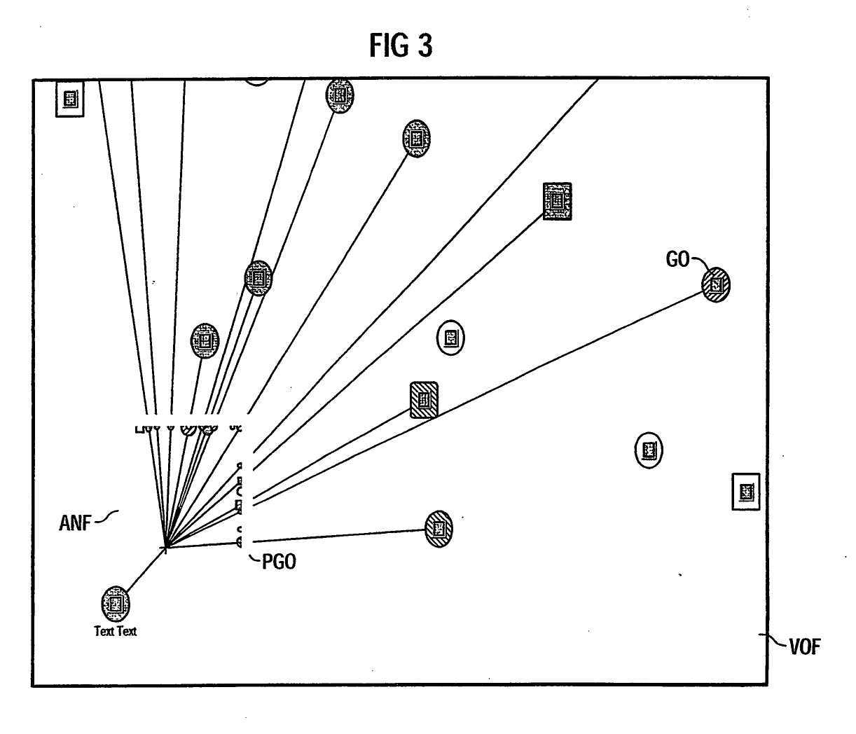

FIG. 3 corresponds to FIG. 2 with the exception that in the projected graphics objects PGO are shown not as lines but rather in reduced and halved form.

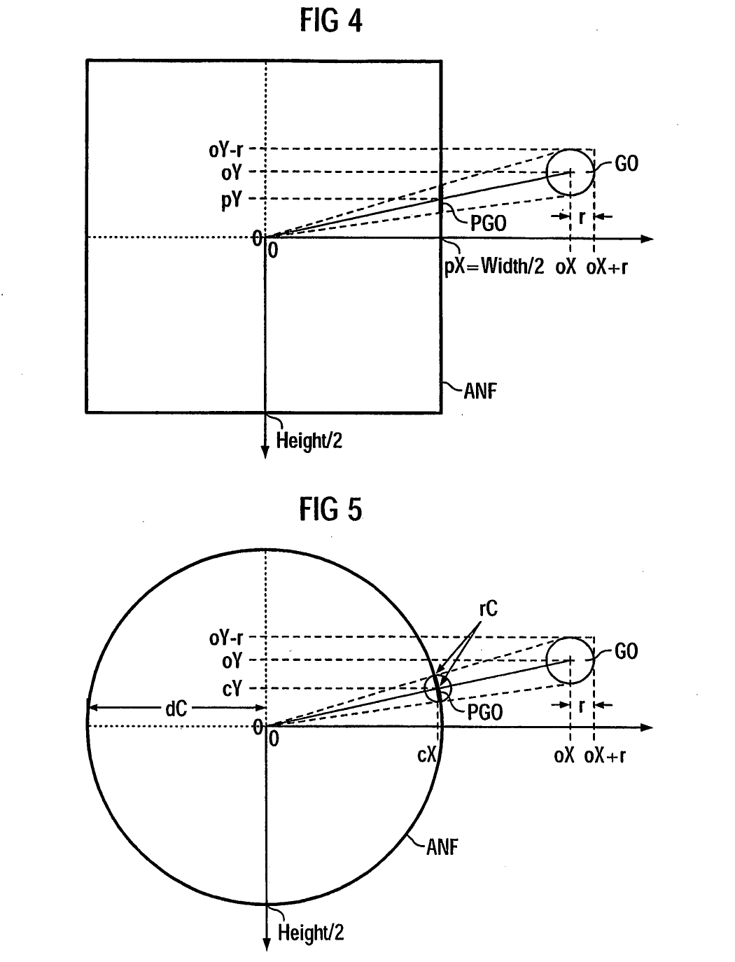

FIG. 4 illustrates a method for calculating projection edges for the case of a rectangular display panel:

If Abs (oX / oY) > dsp.Width / dsp.Height Then
‘right and left

pY = oY / oX * dsp.Width / 2
If oX > 0 Then
‘right

pX = dsp.Width / 2

Else
‘left

pX = −dsp.Width / 2
pY = −pY

End If
disP = Sqr(pX * pX + pY * pY)
rP = rO / disO * disP
s(i).Width = 30
s(i).Height = 2 * rP

Else
‘top and bottom

pX = oX / oY * dsp.Height / 2
If oY > 0 Then
‘bottom

pY = dsp.Height / 2

Else
‘top

pY = −dsp.Height / 2
pX = −pX

End If
disP = Sqr(pX * pX + pY * pY)
rP = rO / disO * disP
s(i).Width = 2 * rP
s(i).Height = 30

End If

FIG. 5 illustrates a method for calculating projection edges for the case of a round display panel:

dc = dsp.Width / 2

| | |
|---|---|
| | f = oX / oY |
| | cY = dc / Sqr(f * f + 1) |
| | cX = f * cY |
| | If (oX > 0 And cX < 0) Or (oX < And cX > 0) Then |
| cX = −cX | |
| | If (oY > 0 And cY < 0) Or (oY < 0 And cY > 0) Then |
| cY = −cY | |
| | rC = rO / oX * cX |
| | s(i).Width = 2 * rC |
| | s(i).Height = 2 * rC |

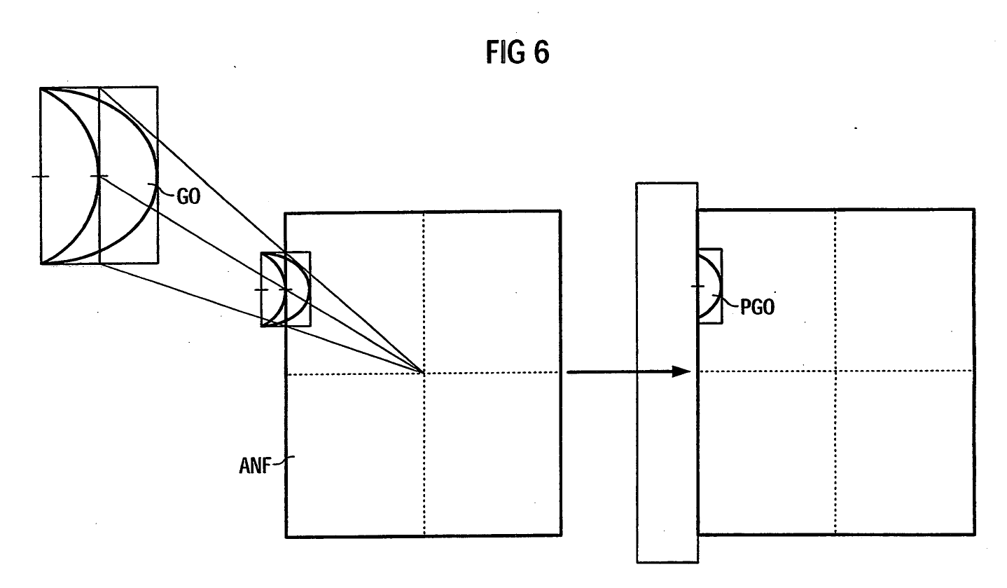

FIGS. 6 to 9 show different representation variants for the projected graphics objects PGO:

In FIG. 6, the graphics object is halved in the center and, following appropriate reduction, is shown in projection on the edge.

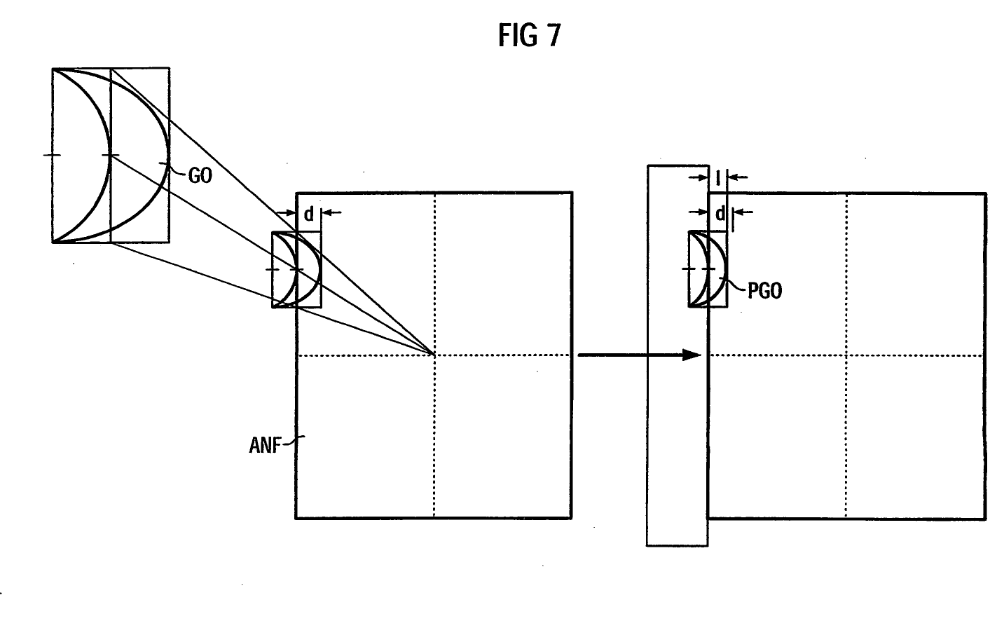

In FIG. 7, the graphics object is first halved and reduced in line with the procedure described in FIG. 6, and then additionally—if it exceeds the threshold with the length 1

—the half-image is distorted again onto the threshold only in the horizontal direction if a left or right projection depiction was previously involved, otherwise the half-image is additionally distorted onto the threshold only in the vertical direction.

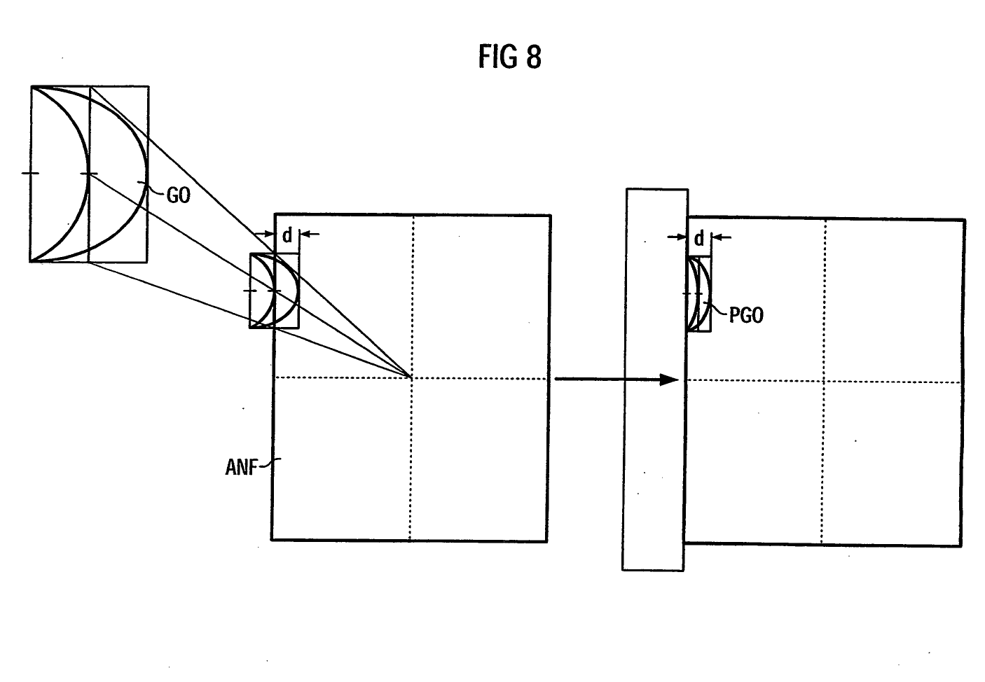

FIG. 8 shows the graphics object, in line with the halved area described in FIG. 6, but is shown in full view. To achieve this, following the operation in FIG. 6, it is distorted by the factor 0.5 and is shown in full view in projection flush to the edge.

In FIG. 9, the graphics object is distorted in hybrid form as described under 7 and 8: first, the graphics object is projected in the horizontal or vertical direction in full on the edge in line with the halved area and distortion described in FIG. 8. In addition, if the threshold 1 is exceeded, as described in FIG. 7, the graphics object is reduced to the length 1 only in the horizontal or vertical direction and is shown flush to the edge.

It should be understood that the various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-7. (canceled)

8. A method for showing graphics objects, comprising:
arranging the graphics objects on a virtual interface panel, wherein the virtual interface panel is larger than a display panel;
displaying a detail from the virtual interface panel on the display panel; and
projecting graphics objects that are arranged outside of the detail shown from the virtual interface panel onto the edge of the display panel.

9. The method as claimed in claim 8, wherein projected graphics objects are shown in reduced form.

10. The method as claimed in claim 8, wherein projected graphics objects are shown in distorted form.

11. The method as claimed in claim 8, wherein projected graphics objects are shown as simply geometric shapes.

12. The method as claimed in claim 8, wherein projected graphics objects are shown as lines along the edge of the display panel.

13. The method as claimed in claim 8, wherein the size of the projected graphics object is set on the basis of the distance between the detail shown from the virtual interface panel and the position of the graphics object.

14. A communication apparatus, comprising:
a display device for implementing a display panel on which graphics objects can be shown; and
a processor device for processing graphics objects to arrange them on a virtual interface panel, wherein the virtual interface panel is larger than a display panel, and wherein the display panel shows a detail from the virtual interface panel, and wherein graphics objects which are arranged outside of the detail shown from the virtual interface panel are projected onto the edge of the display panel.
